(19) United States
(12) Patent Application Publication
(10) Pub. No.: US 2007/0011009 A1
(43) Pub. Date: Jan. 11, 2007

(54) Supporting a concatenative text-to-speech synthesis

(75) Inventors: Jani Nurminen, Lempaala (FI); Sakari Himanen, Tampere (FI); Anssi Ramo, Tampere (FI); Janne Vainio, Lempaala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/177,250

(22) Filed: Jul. 8, 2005

(51) Int. Cl. G10L 13/08

(52) U.S. Cl. 704/260

(57) ABSTRACT

The invention relates to a support of a concatenative TTS synthesis. In order to generate a speech database as a basis for the TTS synthesis, first, a speech processing including a segmental parametric speech encoding of speech data based on a parametric modeling of speech is performed, which results in compressed parameterized speech segments. Then, the compressed parameterized speech segments are assembled in a speech database. In order to synthesize output speech, compressed parameterized speech segments are selected from the speech database based on an available text and decompressed to regain parameterized speech segments. The parameterized speech segments are then concatenated in a parameter domain. The output speech is synthesized based on these concatenated parametric speech segments.

### FIELD OF THE INVENTION

The invention relates to methods, software program products, a database generator, a text-to-speech synthesizer and a system supporting a concatenative text-to-speech synthesis.

### BACKGROUND OF THE INVENTION

Text-to-speech (TTS) synthesizers can be employed in various devices for converting an available text into an audible speech output. The importance of the TTS functionality in general is currently increasing very rapidly as the speech synthesis technology is getting mature enough for products.

A high quality of the speech output, that is, a high naturalness of the speech output, can be achieved with concatenative TTS synthesizers.

Concatenative TTS synthesizers synthesize the output speech by concatenating small clips of actual speech recordings, which are selected from a large speech database. The sizes of the speech clips are different in different concatenative TTS approaches. For most systems, the use of diphones, half-syllables and triphones can be considered to be suitable, since such clips contain most of the transitions and co-articulations while still keeping the total number of clips at a reasonable level. Some systems may also use larger speech clips, but in these cases it is still necessary to also store shorter speech clips, like diphones, in the database, unless the usage of the TTS synthesizers is limited to some specific small vocabulary.

The speech quality offered by a concatenative TTS synthesizer depends largely on the size of the available speech database. A larger database results in a higher quality of the speech output. Therefore, conventional TTS synthesizers capable of synthesizing high quality speech use the concatenative synthesis approach and rely heavily on having available a very large speech database.

Therefore, the speech databases are usually compressed in order to be able to store a given number of speech clips using less memory space. Conventional TTS systems generally use either a proprietary codec or a code-excited linear predictive (CELP) coding model based codec, like for instance the adaptive multirate (AMR) codec. These codecs result in a speech database compression with bit rates of about 10 kbps or slightly below. The used bit rates are thus still rather high. In most high quality concatenative TTS synthesizers, the total size of the speech database is tens or hundreds of megabytes.

In embedded systems, the available memory size, and consequently the naturalness of the output speech, is severely restricted. This has practically prevented the usage of high quality synthesizers in embedded platforms. In some systems, speech coding techniques have been applied to achieve practicable memory figures, but in most cases this has resulted in a significantly degraded speech quality.

In concatenative TTS synthesizers, moreover the post-processing of the concatenated waveforms is typically a problematic task. The employed processing techniques are often computationally expensive and/or may produce artifacts to the output speech.

It may, in particular, be difficult to produce smooth and continuous-sounding speech from small speech clips. The concatenation method used with CELP based solutions, for example, does not always produce optimal results from the viewpoint of continuity.

### SUMMARY OF THE INVENTION

It is an object of the invention to enable a high quality TTS synthesis based on a speech database, which requires a moderate memory space.

A first aspect of the invention deals with the generation of such a speech database, while a second aspect of the invention deals with the use of such a speech database.

For the first aspect of the invention, a method of generating a speech database as a basis for a concatenative TTS synthesis is proposed. The method comprises performing a speech processing, including a segmental parametric speech encoding of speech data based on a parametric modeling of speech. The speech processing results in compressed parameterized speech segments. The method further comprises assembling the compressed parameterized speech segments in a speech database.

For the first aspect of the invention, moreover a database generator for generating a speech database as a basis for a concatenative TTS synthesis is proposed. The database generator comprises processing means adapted to perform a speech processing including a segmental parametric speech encoding of speech data based on a parametric modeling of speech and resulting in compressed parameterized speech segments. The database generator further comprises processing means adapted to assemble the compressed parameterized speech segments in a speech database. It is to be understood that the processing means can be for instance a processing unit executing a suitable software code, a hardware circuit or a combination of both.

For the first aspect of the invention, moreover an electronic device is proposed, which comprises the proposed database generator.

For the first aspect of the invention, moreover a software program product is proposed, in which a software code for generating a speech database as a basis for a concatenative TTS synthesis is stored. When being executed in a processing unit of an electronic device, the software code realizes the steps of the method proposed for the first aspect of the invention.

For the second aspect of the invention, a method enabling a concatenative TTS synthesis based on a speech database is proposed. The speech database is assumed to comprise compressed parameterized speech segments obtained in a speech processing including a segmental parametric speech encoding of speech data using a parametric modeling of speech. The method comprises selecting compressed parameterized speech segments from the speech database based on an available text. The method further comprises decompressing the selected compressed parameterized speech segments to regain parameterized speech segments. The method further comprises concatenating the parameterized speech segments in a parameter domain. The method further comprises synthesizing output speech based on the concatenated parametric speech segments.

For the second aspect of the invention, moreover a TTS synthesizer enabling a concatenative TTS synthesis based on a speech database is proposed. The TTS synthesizer comprises a memory storing a speech database comprising compressed parameterized speech segments obtained in a speech processing including a segmental parametric speech encoding of speech data using a parametric modeling of speech. The TTS synthesizer further comprises processing means adapted to select compressed parameterized speech segments from the database based on an available text. The TTS synthesizer further comprises processing means adapted to decompress the selected compressed parameterized speech segments to regain parameterized speech segments. The TTS synthesizer further comprises processing means adapted to concatenate the parameterized speech segments in a parameter domain. The TTS synthesizer further comprises processing means adapted to synthesize output speech based on the concatenated parametric speech segments. It is to be understood that the processing means can be for instance a processing unit executing a suitable software code, a hardware circuit or a combination of both.

For the second aspect of the invention, moreover an electronic device is proposed, which comprises the proposed TTS synthesizer.

For the second aspect of the invention, moreover a software program product is proposed, in which a software code for enabling a concatenative TTS synthesis based on a speech database is stored. It is assumed again that the speech database comprises compressed parameterized speech segments obtained in a speech processing including a segmental parametric speech encoding of speech data using a parametric modeling of speech. When being executed in a processing unit of an electronic device, the software code realizes the steps of the method proposed for the second aspect of the invention.

Finally, a system is proposed, which comprises the proposed database generator and the proposed concatenative TTS synthesizer.

The invention proceeds from the consideration that a particularly efficient compression of speech data for a speech database can be achieved, if the speech data is first subjected to a segmental parametric speech encoding that is based on a parametric modeling of speech.

Using a parametric speech model has the advantage that it enables a robust estimation of parameters from a speech signal. Moreover, it enables an efficient compression of the resulting parameterized speech segments. Further, it allows reaching a high target speech quality.

A segmental parametric speech encoding includes a segmentation of a source speech signal, which may depend on characteristics of the source speech signal. Such segmentation enables an efficient encoding of each segment depending on a segment type associated to the determined characteristics. The encoding itself may include a compression and result in compressed parameterized speech segments. Alternatively, parameterized speech segments resulting in the encoding may be compressed subsequently.

Selected compressed parameterized speech segments can then be retrieved from the compressed speech database and decompressed into parametric speech segments. The speech segments can be concatenated in the parameter domain as a basis for a high quality speech synthesis. The synthesis can be performed for example using as well a parametric speech codec, in particular the same speech codec as employed for the speech encoding.

Since a higher compression ratio can be achieved with the invention compared to the prior art approaches, the naturalness of the speech output can be improved without increasing the required memory space. Alternatively, the required memory space can be reduced for a given speech quality so that, for example, the TTS functionality can be implemented in a wider range of devices, for instance in mobile phones having a small memory size.

It is also an advantage of the invention that the processing in the parameter domain is very easy and computationally efficient compared to the conventional processing of speech data in the time-domain. Further, the invention is very flexible, as the proposed processing can be implemented in various ways.

Basically, all parametric speech coding models, from the basic LPC10 to the more sophisticated newer approaches, are candidates for the parametric model.

Two alternatives that are particularly well-suited for the implementation of the invention are the sinusoidal model and the waveform interpolation (WI) model. The sinusoidal model has been described for example by R. J. McAulay and T. F. Quatieri in: “Speech analysis-synthesis based on a sinusoidal representation”, IEEE Transactions on Acoustics, Speech, and Signal Processing, Vol. 34, No. 4, 1986, pp. 744-754, 1986. The WI model has been described for example by W. B. Kleijn and W. Granzow in: “Methods for waveform interpolation in speech coding”, Digital Signal Processing, Vol. 1, No. 4, 1991, pp. 215-230.

Both models use a similar parameter set that consists of linear prediction (LP) coefficients, gain, pitch, spectral amplitudes of the LP residual and some kind of voicing information. The main difference between the two models results from the different representations of the spectral amplitudes. The sinusoidal model typically employs harmonically related sinusoids with linear and/or random phases while the WI model represents the spectral amplitudes as slowly and rapidly evolving waveform (SEW and REW) surfaces. Also, the degree of voicing is adjusted differently. In the sinusoidal model the voicing parameter determines the phases for the sinusoids whereas in the WI model voicing is implicitly included as the energy ratio between the SEW and REW components. Both the sinusoidal model and the waveform interpolation model share the advantage that they are roughly consistent with the human speech production system. The linear prediction scheme is a source-and-filter model in which the source approximately corresponds to the excitation and in which the filter models the vocal tract. The gain parameter has a connection to the loudness of speech whereas, during voiced speech, the pitch parameter corresponds to the fundamental frequency of the vibration of vocal cords. Furthermore, the (implicit or explicit) voicing parameter defines the relationship between the periodic and noise-like speech components. The relationship between the spectral amplitudes of the LP residual and the human speech production is more complex and will therefore not be described in this document.

For a segmental parametric speech encoding using a sinusoidal speech model, for example the very low bit rate (VLBR) codec presented in U.S. patent application 2005/0091041 A1 can be employed, which is incorporated by reference herein. The speech synthesis can be based in this case on a corresponding VLBR decoding. The VLBR codec offers a scalable operation on a wide bit rate range from less than 1 kbps to about 5-8 kbps. Considering the conventionally employed bit rate of about 10 kbps, the VLBR encoding thus enables a significantly more efficient database storage while still keeping the speech quality and the intelligibility at a high level. The scalability makes it moreover possible to use different compression ratios in different products. As the bit rate is scalable, it can always be ensured that the speech quality is not degraded by setting the bit rate to a sufficiently high value.

In one embodiment of the invention, the speech processing is performed by an encoder, which is retrained at least before a specific step of the speech processing based on the speech data. By retraining the coder for each database, a maximum efficiency and quality can be achieved, in particular with regard to the compression. The invention can be used for the compression of basically any kind of TTS related speech databases. The details of the employed compression can be selected depending on the desired organization of the speech database.

The speech database may be organized for example to store compressed speech units. The boundaries of such speech units may be selected based on a different criterion than the boundaries of the parameterized speech segments. The boundaries of the speech units may be selected, for example, based on the pronunciation of the language. For assembling the compressed parameterized speech segments in the speech database, the parameterized speech segments are thus distributed to such speech units, where the boundaries of the parameterized speech segments do thus not have to coincide necessarily with the boundaries of the speech units. The distribution can be performed before or after the compression of the parameterized speech segments.

The speech database may further be organized for instance such that assembling the speech units in the speech database comprises grouping the speech units by speech sounds or assembling the speech units by sentences.

If similar units are to be grouped together, for example, the compression may be performed on non-continuous parameterized speech segments and a natural acoustic context for the respective parameterized speech segments. In this case, data for a single speech unit is fed into a codec at a time. Thus, there is a separate output bitstream for each unit. The database organization and the retrieval of the speech units are handled accordingly.

If the database is organized by sentences, in contrast, the compression may be performed on continuous speech data. In this case, speech data for one or more sentences at a time is fed into the codec as continuous speech. Thus, a single output bitstream contains several speech units. During unit retrieval, some kind of location information must be available that allows accessing the correct part of the bitstream, which corresponds to the unit that is to be retrieved.

For a TTS synthesis, first suitable compressed parameterized speech segments have to be selected based on the text that is to be converted into a speech output. Suitable compressed parameterized speech segments can be selected for example by selecting speech units to which the parameterized speech segments have been distributed for storage in the speech database. For selecting suitable speech units from the speech database, parameters of the speech units can be evaluated as additional information.

If the speech database comprises location information for each contained speech unit, the selected speech units may be retrieved from the speech database based on location information for the selected speech units. Alternatively, selected speech units may be retrieved from the database based at least partly on decompressed information in the speech units. The latter alternative is of particular interest, if the database is organized by sentences.

The storage of parametric speech data in the speech database and the concatenation in the parameter domain enable as well a further processing of the speech data before, during or after the concatenation.

The option of a speech processing in the parameter domain enables in particular an easy smoothing of parameters at concatenation boundaries between respectively two parameterized speech segments. This reduces artifacts at the concatenation boundaries by smoothing audible discontinuities and increases thus the quality of the synthesized speech significantly.

A further processing in the parameter domain may moreover comprise deleting unnecessary parts of the parameterized speech segments.

Some parameters of a parametric speech model have a direct physical meaning in the output speech. This enables as well an easy modification of voice characteristics in the parameter domain as desired without causing an additional quality degradation. This provides significant advantages, for example, if there is a need to modify the identity of the speaker or to modify emotional characteristics.

The invention can be applied to all concatenative speech synthesizers, regardless of the implementation details. It can also be employed for all electronic devices and applications which are to offer a TTS functionality, for example for PDAs, for mobile phones, for multimedia systems, for user interfaces, for games, etc. obviously, the invention is of particular interest for electronic devices having a small memory capacity. Further, the invention can be used with all languages and with different kinds of speech databases.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a communication system according to an embodiment of the invention;

FIG. 2 is a flow chart illustrating an operation in a database generator of the communication system of FIG. 1;

FIG. 3 is a flow chart illustrating an operation in a mobile station of the communication system of FIG. 1; and

FIG. 4 presents two diagrams illustrating a parametric concatenation without and with boundary smoothing.

### DETAILED DESCRIPTION OF THE INVENTION

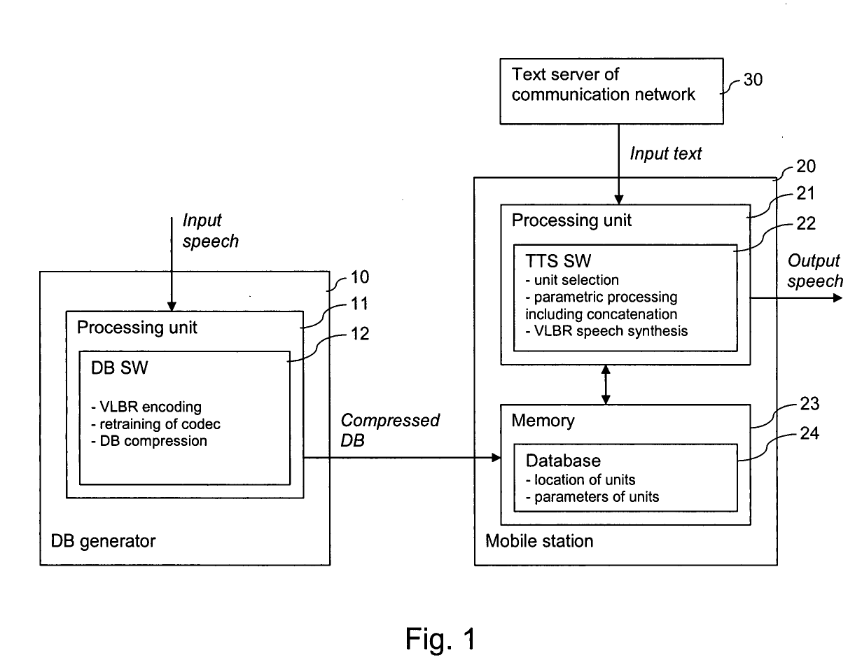

FIG. 1 is a schematic block diagram of a communication system, which enables a high quality TTS synthesis using little memory space in accordance with an exemplary embodiment of the invention.

The communication system comprises a mobile station 20 enabling a concatenative text-to-speech conversion. The mobile station 20 includes a processing unit 21, which is adapted to run software program codes implemented in the mobile device. One of these software program codes is a TTS synthesis software code (TTS SW) 22. The mobile station 20 further includes a memory 23, which is accessible by the processing unit 21. The mobile station 20 is adapted to receive a speech database 24 for storage in the memory 23, for example via a Bluetooth™ or IR interface or via a radio interface to a mobile communication network, etc. Moreover, the mobile station 20 is adapted to receive input text for a text-to-speech conversion, for example, via a key pad, a Bluetooth™ or IR interface or via a radio interface to a mobile communication network, etc. Moreover, the mobile station 20 is adapted to output speech generated in a text-to-speech conversion via a loudspeaker and/or to store speech generated in a text-to-speech conversion to a file or in a memory 23 for later usage, instead of playing it immediately. The processing unit 21 running the TTS software code 22 and a speech database 24 stored in the memory 23 form a concatenative TTS synthesizer.

The communication system comprises in addition a database (DB) generator 10 enabling the generation of a speech database for a concatenative text-to-speech conversion. The database generator 10 includes a processing unit 11, which is adapted to run software program codes, including a database generation software code (DB SW) 12. The database generator 10 is adapted to generate a compressed database based on available speech and to output a compressed database, for instance via a Bluetooth™ or IR interface or via means for accessing the Internet.

The database generator 10 can be for example a device of a mobile station manufacturer, which is able to output a speech database for storage in the memory 23 of mobile stations 20 during the manufacturing process. Alternatively, the database generator 10 could be a server which is able to provide a speech database to a mobile station later on upon request by a user, for example via the Internet and a mobile communication network or via another user device like a PC. At least in the latter cases, the storage in the mobile device 20 may be supported by the processing unit 21 of the mobile device 20. Further alternatively, the database generator 10 could also be a part of the mobile station 20 itself. In this case, the processing unit 21 of the mobile station 20 could perform as well the tasks of the processing unit 11.

The communication system may comprise in addition a text server 30 adapted to provide text to the mobile station 20, for example an SMS server of a mobile communication network adapted to forward short messages to the mobile station 20. It has to be noted, though, that a text input to the mobile station 20 may equally be provided by any other text source than a server 30.

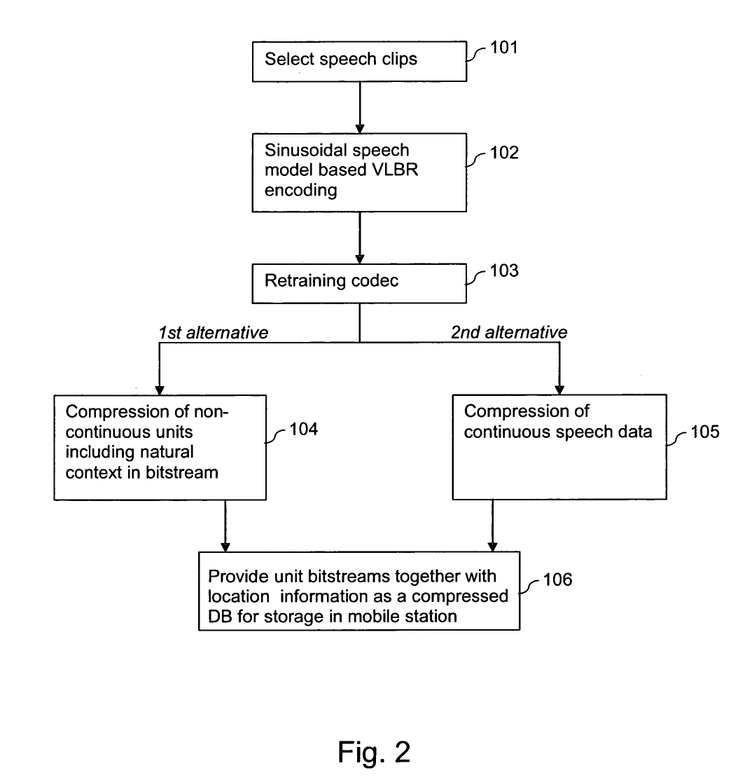

The TTS synthesis related operations in the communication system of FIG. 1 will now be described with reference to FIGS. 2 to 4.

In a preparatory step (not shown), speech sentences are recorded and the speech recordings are annotated. This step is identical to the corresponding task employed in the creation of speech databases for conventional concatenative TTS synthesizers. Usually, the speech is recorded in a recording studio using another apparatus than the DB generator 10. The resulting speech database may then be stored in the database generator 10 for later usage.

FIG. 2 is a flow chart illustrating the generation of a speech database in the database generator 10 by the database software code 12.

In a first step, speech clips which are to be stored in a parametric database are selected from the recorded speech sentences (step 101). Each speech clip may correspond for example to a diphone, a half-syllable or a triphone, as mentioned above.

Next, a VLBR codec based encoding is applied to the selected speech clips in order to obtain a parametric representation of the speech clips (step 102). It is to be understood, though, that another parametric coding approach could be used as well instead of a VLBR coding.

The VLBR codec is a segmental parametric speech codec that is based on a sinusoidal modeling of speech. The parameters of the sinusoidal speech model are pitch, line spectrum frequencies (LSFs) obtained with a linear prediction scheme, gain, spectral amplitudes, and voicing. The speech signal is segmented into a plurality of segments based on the characteristics of the speech signal for enhancing the coding efficiency of the parametric speech coder. The segmentation can be based either on the parametric representation of speech or on the speech signal itself. The segments are chosen such that the intra-segment similarity of the speech parameters is high. In addition, each segment is classified into one of various segment types that are based on the properties of the speech signal, for instance one of the segment types silent, voiced, unvoiced, and transition. As a result of this segmentation technique, each segment can be efficiently coded using a coding scheme designed specifically for the corresponding segment type.

For the parameter estimation, the VLBR encoding comprises a speech analysis. In this analysis, the selected speech clips are analyzed with the intention of finding the underlying parameter tracks. The analysis window is moved with small steps of 5-20 ms in order to capture even the rapid fluctuations in the time-varying evolution of the parameter values. The parameter tracks for a respective speech clip form a VLBR parameter track for one or more VLBR segments.

The bit rate of the VLBR codec that is used for encoding a respective VLBR segment is adaptive and scalable. The VLBR codec is capable of achieving a good quality, that is, perfectly intelligible speech, at bit rates of about 1.0 kbps or even below.

Next, the VLBR segments are compressed using a compression codec. The compression results in a bitstream that is divided into small speech units. The VLBR segments are not necessarily in direct relationship with the speech units. One unit may contain more than one segment, and the segment boundaries may not be aligned with the speech unit boundaries.

In cases in which there co-exist several instances of the codec codebooks retrained specifically for different databases, the codebook used in the VLBR codec is much smaller than the total size of a typical TTS speech database, that is, less than 100 kilobytes versus tens of megabytes. Therefore, the compression codec can be retrained for each speech database before the actual compression operation, in order to achieve the best compression ratio and speech quality with a respective speech database (step 103). The retraining can be done using conventional training methods with the uncompressed TTS database resulting in the VLBR encoding as the training material.

Usually, speech databases are organized such that similar compressed units are grouped together, or they are organized as sentences.

In the first alternative, non-continuous units are compressed (step 104). In this case, the compression is done using the original recorded sentences in such a way that the natural acoustic context is also given as input into the encoder to enhance the continuity of the speech output. Parts of the natural context can also be included in the bitstream of each speech unit. The VLBR segment boundaries are forced into the locations of the possibly extended speech unit boundaries. After the compression, the compressed database is organized into its final form. The bitstreams generated from the different instances of the same diphone may, for example, be grouped together, etc.

In the second alternative, continuous speech data is compressed (step 105). In this case, a whole sentence is given as input into the encoder. The VLBR segment boundaries can either be forced into the locations of the speech unit boundaries or they can be placed according to the results of the speech analysis performed by the VLBR encoder. In the first approach, the retrieval time is minimized while the second approach maximizes the compression efficiency.

Since the bit rate of the VLBR codec is variable, it is necessary to also provide location information for each speech unit. The compressed speech database includes thus the bitstreams for each speech unit and location information.

Steps 101 to 105 are an exemplary implementation of the speech processing according to the invention. It is to be understood that the compression could also be an intrinsic part of the segmental parametric speech encoding.

Finally, the compressed speech database is provided by the database generator 10 to the mobile station 20 (step 106).

The mobile station 20 stores the speech database 24 in the memory 23 as a basis for its TTS functionality.

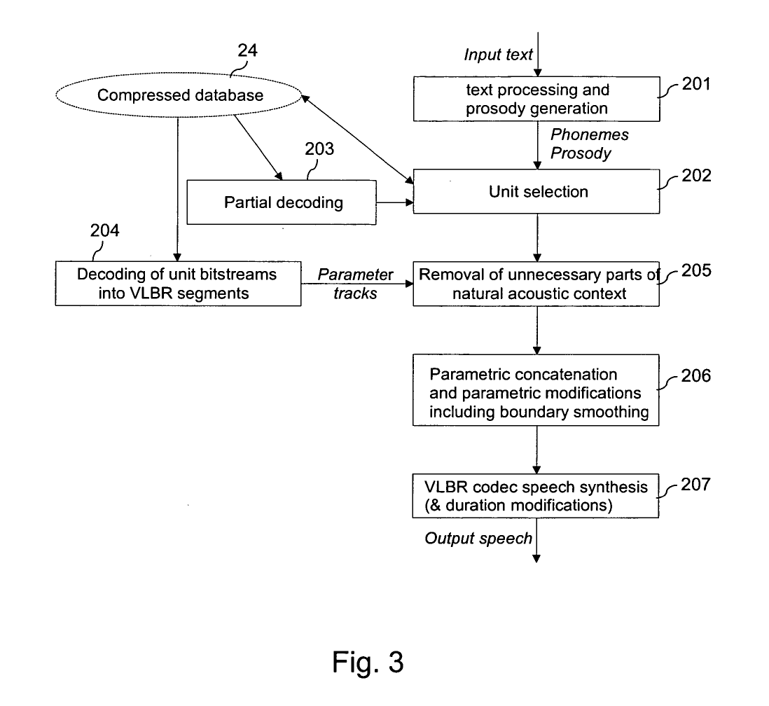

FIG. 3 is a flow chart illustrating a text-to-speech conversion of input text performed in the mobile station 20 by the TTS synthesis software code 22 based on a stored speech database 24.

The input text may be for example text that is already stored in the mobile phone 20 and is now selected for a text-to-speech conversion by a user, text that is input by a user, for example by means of a keypad, text that is provided by another user device in a direct wired or wireless connection to the mobile station 20, text that is provided to the mobile station 20 by a server 30 via a mobile communication network, etc.

The text is received by a TTS front-end realized by the TTS synthesis software code 22. The TTS front-end performs a text processing on the input text to obtain phonemes and their prosody (step 201).

Phonemes and prosody are then used as a basis for a selection of those speech units in the database 24 which are to be concatenated for a speech synthesis (step 202).

The VLBR parameters belonging to the stored speech unit can be used as additional information in the unit selection of step 202, leading possibly to an enhanced speech quality. Also, if the VLBR parameters are used in the selection, it is no longer necessary to store side information such as pitch contours for the purpose of unit selection, since this information is already available in the unit bitstreams stored in the speech database 24. Due to the segmental parametric coding approach and due to the bitstream format used in the VLBR encoding, it is possible to decode only the parameters which are relevant for the unit selection, for example a pitch contour, without a need to decode the whole parametric representation or the actual speech segment (step 203).

The parameter contours of the selected speech units are then retrieved separately for each of the units from the speech database 24 for decompression.

The retrieval and decompression of the selected speech units can be implemented in two different ways, depending on the approach used in the database compression described above with reference to steps 104 and 105 of FIG. 2.

In the first alternative, in which the speech database 24 comprises compressed non-continuous speech units, each non-continuous speech unit is retrieved directly based on the location information for the selected speech units, the location of each unit being stored as side information in the database 24, as mentioned above. The retrieved speech unit is decoded as such, that is, the unit bitstream is decompressed to obtain the VLBR segment or segments comprising the VLBR parameter tracks (step 204). Possible additional acoustic context can be deleted after the decompression (step 205), either before or during a concatenation.

In the second alternative, in which the speech database 24 comprises speech units from compressed continuous speech data, it may be necessary to decode additional data, if the segment boundaries are not forced into the unit boundaries. The selection of the speech unit is performed by determining how well a respective speech unit fits the particular purpose and how well it fits to the neighboring units in the concatenation. The decoded additional data can be used in measuring how similar the natural context is to the context in the concatenation. After decompression of a retrieved speech unit to obtain the VLBR segments comprising the VLBR parameter tracks, the possible additional parameter values at the beginning of the first VLBR segment and at the end of the last VLBR segment of the speech unit should be deleted prior to a concatenation (step 205).

The VLBR segments resulting in the decompression of the speech units are then concatenated. The concatenation is done in the parametric domain using the VLBR parameters. Before, during or after the concatenation, some parametric modifications may be applied to the VLBR parameters. (step 206)

A parametric modification may be carried out in particular in order to obtain a smoothed concatenation. More specifically, the LSF and the pitch values can be smoothed at the unit boundaries to achieve a better continuity. For the time instants at which the pitch is modified, the residual amplitude spectrum is also modified to take into account the changed number of pitch harmonics.

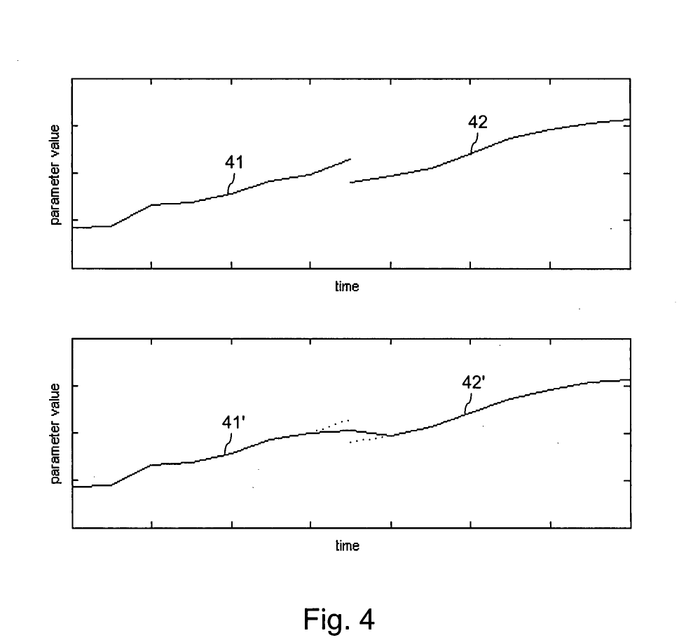

The relevance of the boundary smoothing is illustrated in FIG. 4. FIG. 4 presents in an upper diagram the course of a parameter value over time in case of the basic concatenation without boundary smoothing and in a lower diagram the course of a parameter value over time in the case of a concatenation with boundary smoothing. The parameter value can be for instance the pitch value.

It can be seen in the upper diagram that when a parameter track 41 of a first VLBR segment is concatenated with a parameter track 42 of a second VLBR segment, the resulting parameter track is clearly discontinuous in the case of a concatenation without boundary smoothing.

It can further be seen in the lower diagram that it can easily be ensured that the concatenated parameter track is always continuous and reasonably smooth by means of a boundary smoothing between the first parameter track 41′ and the second parameter track 42′. The original course of the parameter tracks 41, 42 at the boundary is depicted in this diagram with dashed lines. In general, a continuous parameter track enhances the perceptual performance in the boundary areas.

It is to be understood that it is also possible to perform various other kinds of parametric processing to the VLBR segments.

There may be for example a need to modify the pitch contour of some VLBR segments before the concatenation. In practice, this can be achieved by modifying the values of the pitch parameter and the spectral amplitudes to match the target contour. In addition, the gain parameter contour can be adjusted to achieve a desired stress in intonation. Only after the intra-unit prosody fits the target prosody, the neighboring units are concatenated in the parametric domain. It is also possible to modify all the parameters in a systematic way with the goal of changing the identity of the speaker or the voice quality in some other way.

Only after the concatenation and all appropriate modifications are completed, a VLBR decoder, realized by the TTS software code 22, performs the speech synthesis (step 207). The speech synthesis includes converting the parameter contours into time-domain speech waveform. The concatenated parametric representation is used as the input and the VLBR decoder produces the speech output. For a minimized delay, the conversion can be done for one small block at a time. However, at concatenation boundaries it is important to have some data from both VLBR segments that are involved in the concatenation.

The speech synthesis does not require any mandatory modifications to a conventional basic VLBR codec itself. In general, the only requirement is a separation of the dequantization and speech synthesis parts of the codec.

It has to be noted that a high quality duration modification may be performed during the speech synthesis, which modifies the durations of the VLBR segments without audible quality loss.

Finally, the synthesized speech may be provided as audible output via a loudspeaker of the mobile station 20. Alternatively, it may be stored for instance in memory 23 for a later usage.

On the whole, the presented system enables a good trade-off between computational complexity, memory consumption and speech quality.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of generating a speech database as a basis for a concatenative text-to-speech synthesis, said method comprising:
performing a speech processing including a segmental parametric speech encoding of speech data based on a parametric modeling of speech and resulting in compressed parameterized speech segments; and
assembling said compressed parameterized speech segments in a speech database.

2. The method according to claim 1, wherein said parametric modeling of speech is one of a sinusoidal modeling and a waveform interpolation modeling.

3. The method according to claim 1, wherein said segmental parametric speech encoding is a very low bit rate encoding.

4. The method according to claim 1, wherein said speech processing is performed by an encoder that is retrained for said speech processing based on said speech data.

5. The method according to claim 1, wherein said speech processing includes a compression performed on non-continuous parameterized speech segments and a natural acoustic context for the respective parameterized speech segments.

6. The method according to claim 1, wherein said speech processing includes a compression performed on continuous speech data.

7. The method according to claim 1, wherein said compressed parameterized speech segments are distributed in said speech database to speech units, and wherein said assembling of compressed speech segments in a speech database comprises grouping said speech units by speech sounds in said speech database.

8. The method according to claim 1, wherein said compressed parameterized speech segments are distributed in said speech database to speech units, and wherein said assembling of compressed speech segments in a speech database comprises assembling said speech units by sentences in said speech database.

9. A database generator for generating a speech database as a basis for a concatenative text-to-speech synthesis, said database generator comprising:
processing means adapted to perform a speech processing including a segmental parametric speech encoding of speech data based on a parametric modeling of speech and resulting in compressed parameterized speech segments; and
processing means adapted to assemble said compressed parameterized speech segments in a speech database.

10. An electronic device comprising the database generator of claim 9.

11. A software program product in which a software code for generating a speech database as a basis for a concatenative text-to-speech synthesis is stored, said software code realizing the following steps when being executed in a processing unit of an electronic device:
performing a speech processing including a segmental parametric speech encoding of speech data based on a parametric modeling of speech and resulting in compressed parameterized speech segments; and
assembling said compressed parameterized speech segments in a speech database.

12. A method enabling a concatenative text-to-speech synthesis based on a speech database comprising compressed parameterized speech segments obtained in a speech processing, said speech processing including a segmental parametric speech encoding of speech data using a parametric modeling of speech, said method comprising:
selecting compressed parameterized speech segments from said speech database based on an available text;
decompressing said selected compressed parameterized speech segments to regain parameterized speech segments;
concatenating said parameterized speech segments in a parameter domain; and
synthesizing output speech based on said concatenated parametric speech segments.

13. The method according to claim 12, wherein said parametric modeling of speech is one of a sinusoidal modeling and a waveform interpolation modeling.

14. The method according to claim 12, wherein said compressed parameterized speech segments are distributed in said speech database to compressed speech units, and wherein selecting compressed parameterized speech segments from said speech database comprises evaluating parameters of said speech units as a basis for said selection.

15. The method according to claim 12, wherein said compressed parameterized speech segments are distributed in said speech database to compressed speech units, and wherein selected compressed parameterized speech segments are retrieved from said speech database for decompression based at least partly on information in said speech units.

16. The method according to claim 12, comprising a further processing of said parameterized speech segments in said parameter domain.

17. The method according to claim 16, wherein said further processing comprises deleting unnecessary parts of said parameterized speech segments.

18. The method according to claim 16, wherein said further processing comprises smoothing parameters at concatenation boundaries between respectively two parameterized speech segments.

19. The method according to claim 16, wherein said further processing comprises modifying voice characteristics of said parameterized speech segments.

20. The method according to claim 12, wherein synthesizing said output speech is performed using a parametric speech codec.

21. The method according to claim 12, wherein synthesizing said output speech is based on a very low bit rate decoding.

22. A text-to-speech synthesizer enabling a concatenative text-to-speech synthesis based on a speech database, said text-to-speech synthesizer comprising:
a memory storing a speech database comprising compressed parameterized speech segments obtained in a speech processing, said speech processing including a segmental parametric speech encoding of speech data using a parametric modeling of speech;
processing means adapted to select compressed parameterized speech segments from said speech database based on an available text;
processing means adapted to decompress said selected compressed parameterized speech segments to regain parameterized speech segments;
processing means adapted to concatenate said parameterized speech segments in a parameter domain; and
processing means adapted to synthesize output speech based on said concatenated parametric speech segments.

23. An electronic device comprising the text-to-speech synthesizer of claim 22.

24. A software program product in which a software code is stored on a readable medium, the software code for enabling a concatenative text-to-speech synthesis based on a speech database comprising compressed parameterized speech segments obtained in a speech processing, said speech processing including a segmental parametric speech encoding of speech data using a parametric modeling of speech, said software code realizing the following steps being executed in a processing unit of an electronic device:
selecting compressed parameterized speech segments from said speech database based on an available text;
decompressing said selected compressed parameterized speech segments to regain parameterized speech segments;
concatenating said parameterized speech segments in a parameter domain; and
synthesizing output speech based on said concatenated parametric speech segments.

25. A system comprising the database generator of claim 9 and the text-to-speech synthesizer of claim 22.
